(19) United States
(12) Patent Application Publication
(10) Pub. No.: US 2019/0094535 A1
(43) Pub. Date: Mar. 28, 2019

(54) WIFI ENABLED HEAD UP DISPLAY (HUD)

(71) Applicant: Panasonic Automotive Systems Company of America, Division of Panasonic Corporation of North America, Peachtree City, GA (US)

(72) Inventors: EDO OMANOVIC, MADISON HEIGHTS, MI (US); PETER SOHLDEN, SHELBY TOWNSHIP, MI (US)

(73) Assignee: Panasonic Automotive Systems Company of America, Division of Panasonic Corporation of North America

(21) Appl. No.: 16/139,367

(22) Filed: Sep. 24, 2018

Related U.S. Application Data
(60) Provisional application No. 62/561,893, filed on Sep. 22, 2017.

(51) Int. Cl. G02B 27/01; G09G 3/16; H04N 7/18; B60R 1/12

(52) U.S. Cl. CPC G02B 27/0101; G09G 3/16; H04N 7/18; B60R 2300/205; G09G 2370/16; G02B 2027/014; B60R 1/12

(57) ABSTRACT

A head up display arrangement for a motor vehicle includes at least one camera capturing images of a scene outside of the motor vehicle, and wirelessly transmitting first video signals indicative of the captured images. A receiver wirelessly receives the first video signals and transmits second video signals dependent upon the first video signals. A head up display system is communicatively coupled to the receiver and receives the second video signals. The head up display system reflects a light field off of a windshield of the motor vehicle such that the reflection is visible to a driver of the vehicle as a virtual image. The light field is dependent upon the second video signals.

### CROSS-REFERENCE TO RELATED APPLICATION

This application claims benefit of U.S. Provisional Application No. 62/561,893 filed on Sep. 22, 2017, which the disclosure of which is hereby incorporated by reference in its entirety for all purposes.

### FIELD OF INVENTION

The disclosure relates to a head up display (HUD) system in a motor vehicle.

### BACKGROUND OF THE INVENTION

A head up display system emits light that reflects from the front windshield to be seen by the driver. The light appears to come from a virtual image in front of the driver and in front of the windshield.

Conventional head up displays create the virtual image by first using a display to create an image. Next, the light from the image is reflected from one or more mirrors, and then the light from the mirrors is reflected from the windshield. The minors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

Currently, head up displays (HUDs) receive their video signal either from the in-vehicle instrument cluster or generate their own graphics. The HUD is packaged within the instrument panel and getting video data from anywhere besides the cluster is very difficult. Currently, all video inputs to the HUD are via cables.

### SUMMARY

By wirelessly connecting to an exterior camera, the present invention may display things like images captured by side mounted and rear mounted cameras. The invention may also enable the HUD to directly connect to WiFi devices like smartphones and thereby create personalized user interfaces.

In one embodiment, the invention comprises a head up display arrangement for a motor vehicle, including at least one camera capturing images of a scene outside of the motor vehicle. The at least one camera wirelessly transmits first video signals indicative of the captured images. A receiver wirelessly receives the first video signals and transmits second video signals dependent upon the first video signals. A head up display system is communicatively coupled to the receiver and receives the second video signals. The head up display system reflects a light field off of a windshield of the motor vehicle such that the reflection is visible to a driver of the vehicle as a virtual image. The light field is dependent upon the second video signals.

In another embodiment, the invention comprises a display method for a motor vehicle, including capturing images of a scene outside of the motor vehicle. First video signals indicative of the captured images are wirelessly transmitted. The first video signals are wirelessly received. Second video signals are transmitted to a head up display. The second video signals are dependent upon the first video signals. The second video signals are received at the head up display. A light field is reflected off of a windshield of the motor vehicle such that the reflection is visible to a driver of the vehicle as a virtual image. The light field is dependent upon the second video signals.

In yet another embodiment, the invention comprises a head up display arrangement for a motor vehicle. The arrangement includes a plurality of WiFi transmitting cameras capturing images of a scene outside of the motor vehicle, and wirelessly transmitting first video signals indicative of the captured images. A WiFi receiver wirelessly receives the first video signals and transmits second video signals dependent upon the first video signals. A head up display system is communicatively coupled to the WiFi receiver and receives the second video signals. The head up display system produces a virtual image that is visible to a driver of the vehicle. The virtual image is dependent upon the second video signals.

An advantage of the present invention is that, by virtue of having WiFi capability, the HUD can directly display camera data, smartphone data, or data from any other WiFi device directly on the windshield in front of the driver.

Another advantage of the present invention is that, by wirelessly connecting to the devices, the amount of components necessary around the critical package space is minimized.

### BRIEF DESCRIPTION OF THE DRAWINGS

A better understanding of the present invention will he had upon reference to the following description in conjunction with the accompanying drawings.

FIG. 1 is an overhead schematic view of one embodiment of a WiFi-enabled head up display arrangement of the present invention.

FIG. 2 is a plan view of one example embodiment of a virtual image produced by the rear-view camera of FIG. 1 according to the present invention.

FIG. 3 is a block diagram of another embodiment of a WiFi-enabled head up display arrangement of the present invention.

FIG. 4 is a flow chart of one embodiment of a display method of the present invention for a motor vehicle.

### DETAILED DESCRIPTION OF THE PREFERRED EMBODIMENTS

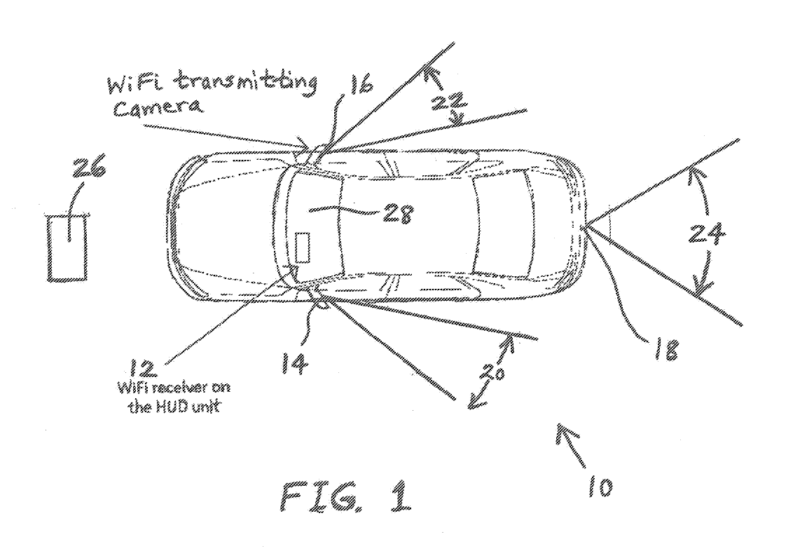

FIG. 1 illustrates one example embodiment of a WiFi-enabled head up display HUD arrangement 10 of the present invention, including a WiFi receiver 12 on the HUD unit, a left side WiFi transmitting camera 14, a right side WiFi transmitting camera 16, and a rear view WiFi transmitting camera 18. Cameras 14, 16, 18 capture images within respective field of views 20, 22, 24. These captured images may be wirelessly transmitted from cameras 14, 16, 18 to WiFi receiver 12 and thereby included in a virtual image 26 that may appear to a driver to be outside of a front windshield 28.

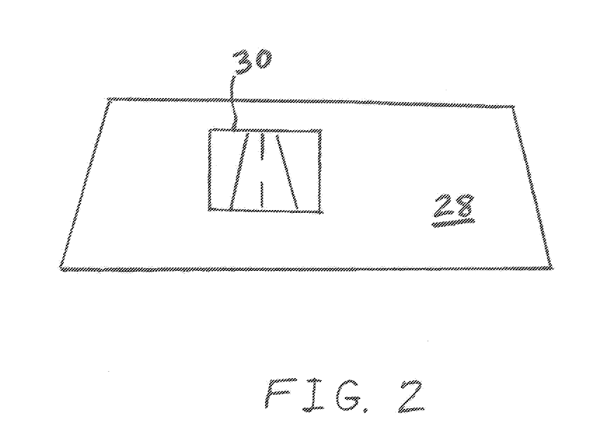

FIG. 2 illustrates a plan view of one example embodiment of a virtual image 30 produced by rear view camera 18 of FIG. 1 on windshield 28 according to the present invention. FIG. 2 illustrates the view of virtual image 30 as seen by the driver.

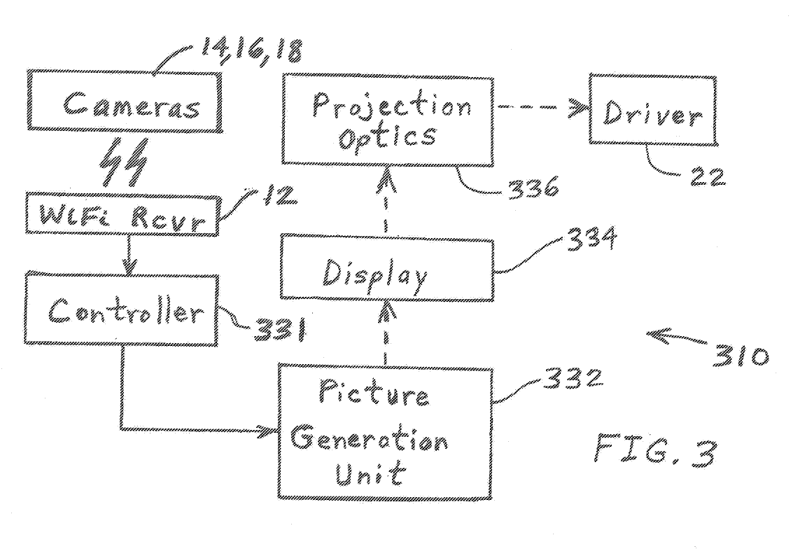

FIG. 3 illustrates another example embodiment of a WiFi-enabled head up display arrangement 310 of the present invention, including WiFi transmitting cameras 14, 16, 18 in wireless communication with a WiFi receiver 12. Arrangement 310 also includes an electronic controller 331, a picture generation unit 332, a display screen 334, and projection optics 336 creating a virtual image visible by a human driver 22. The brightness of the image may be controlled by controller 331 so the image is clearly visible against the background scene. Projection optics 336 may include one or more mirrors that reflect a light field produced by display 334 onto the windshield. The windshield again reflects the light field to driver 22 such that the light appears to the driver as a virtual image that is on or outside of the windshield.

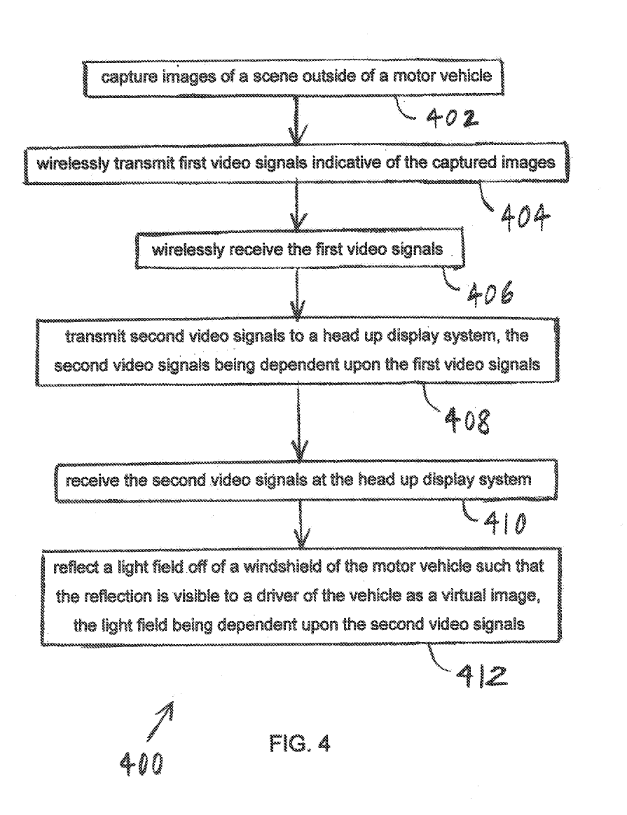

FIG. 4 illustrates one embodiment of a display method 400 of the present invention for a motor vehicle. In a first step 402, images of a scene outside of the motor vehicle are captured. For example, cameras 14, 16, 18 capture images within respective field of views 20, 22, 24.

Next, in step 404, first video signals indicative of the captured images are wirelessly transmitted. For example, these captured images may be wirelessly transmitted from cameras 14, 16, 18 to WiFi receiver 12.

In a next step 406, the first video signals are wirelessly received. For example, WiFi receiver 12 may wirelessly receive the captured images transmitted from cameras 14, 16, 18.

In step 408, second video signals are transmitted to a head up display system. The second video signals are dependent upon the first video signals. For example, a signal based on the captured images may be transmitted from WiFi receiver 12 to controller 331 of a head up display system.

Next, in step 410, the second video signals are received at the head up display system. For example, controller 331 may receive the signal from WiFi receiver 12.

In a final step 412, a light field is reflected off of a windshield of the motor vehicle such that the reflection is visible to a driver of the vehicle as a virtual image. The light field is dependent upon the second video signals. For example, PGU 332, display 334 and projection optics 336 may produce a light field based on the signal received from WiFi receiver 12 such that the light field is reflected off of windshield 28, and such that the reflection is visible to a driver of the vehicle as virtual image 26.

The invention has been described as wirelessly connecting the HUD to WiFi devices. However, in another embodiment, the HUD is directly connected to WiFi devices and cameras via a cable.

The foregoing description may refer to “motor vehicle”, “automobile”, “automotive”, or similar expressions. It is to he understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to he understood therefrom for modifications can be made by those skilled in the art upon reading this disclosure and may be made without departing from the spirit of the invention.

What is claimed is:

1. A head up display arrangement for a motor vehicle, the arrangement comprising:
at least one camera configured to:
capture images of a scene outside of the motor vehicle; and
wirelessly transmit first video signals indicative of the captured images;
a receiver configured to wirelessly receive the first video signals and transmit second video signals dependent upon the first video signals; and
a head up display system communicatively coupled to the receiver and configured to:
receive the second video signals; and
reflect a light field off of a windshield of the motor vehicle such that the reflection is visible to a driver of the vehicle as a virtual image, the light field being dependent upon the second video signals.

2. The head up display arrangement of claim 1 wherein the at least one camera comprises at least one WiFi transmitting camera.

3. The head up display arrangement of claim 1 wherein the receiver comprises a WiFi receiver.

4. The head up display arrangement of claim 1 wherein the at least one camera. comprises a rear-view camera.

5. The head up display arrangement of claim 1 wherein the head up display system includes projection optics having at least one mirror.

6. The head up display arrangement of claim 1 wherein the virtual image appears to the driver to be outside the windshield.

7. The head up display arrangement of claim 1 wherein the at least one camera comprises a side view camera.

8. A display method for a motor vehicle, the method comprising:
capturing images of a scene outside of the motor vehicle;
wirelessly transmitting first video signals indicative of the captured images;
wirelessly receiving the first video signals;
transmitting second video signals to a head up display system, the second video signals being dependent upon the first video signals;
receiving the second video signals at the head up display system; and
reflecting a light field off of a windshield of the motor vehicle such that the reflection is visible to a driver of the vehicle as a virtual image, the light field being dependent upon the second video signals.

9. The display method of claim 8 wherein the images are captured by at least one WiFi transmitting camera.

10. The display method of claim 8 wherein the first video signals are received by a WiFi receiver.

11. The display method of claim 8 wherein the images are captured by a rear-view camera.

12. The display method of claim 8 wherein the head up display system includes projection optics having at least one mirror.

13. The display method of claim 8 wherein the virtual image appears to the driver to be outside the windshield.

14. The display method of claim 8 wherein the images are captured by at least one side view camera.

15. A head up display arrangement for a motor vehicle, the arrangement comprising:
a plurality of WiFi transmitting cameras configured to:
capture images of a scene outside of the motor vehicle; and
wirelessly transmit first video signals indicative of the captured images;
a WiFi receiver configured to wirelessly receive the first video signals and transmit second video signals dependent upon the first video signals; and
a head up display system communicatively coupled to the WiFi receiver and configured to:
receive the second video signals; and.
produce a virtual image that is visible to a driver of the vehicle, the virtual image being dependent upon the second video signals.

16. The head up display arrangement of claim 15 wherein the head up display system is configured to reflect a tight field off of a windshield of the motor vehicle to thereby produce the virtual image.

17. The head up display arrangement of claim 15 wherein the cameras comprise a rear-view camera.

18. The head up display arrangement of claim 15 wherein the head up display system includes projection optics having at least one mirror.

19. The head up display arrangement of claim 15 wherein the virtual image appears to the driver to be outside the windshield.

20. The head up display arrangement of claim 15 wherein the cameras comprise a side view camera.
